(19) United States
(12) Patent Application Publication
(10) Pub. No.: US 2017/0039888 A1
(43) Pub. Date: Feb. 9, 2017

(54) Method to teach and learn Chinese

(71) Applicant: YUN WANG, HANGZHOU (CN)

(72) Inventor: YUN WANG, HANGZHOU (CN)

(21) Appl. No.: 15/230,478

(22) Filed: Aug. 7, 2016

Related U.S. Application Data
(60) Provisional application No. 62/202,699, filed on Aug. 7, 2015.

(51) Int. Cl. G09B 19/08

(52) U.S. Cl. CPC G09B 19/08

(57) ABSTRACT

The present invention provides a method to teach and learn Chinese Pin Yin. Specifically, the method is directed to learn all Finals in Chinese Pin Yin. The method starts from the fundamental 6 Single Finals (vowels) and is gradually built up to other 29 compound Finals in a very logical manner. The method described in the present invention links the six single Finals with Compound Finals, so that all the Finals can be are mapped very logically in mind. In experimental teaching, this method has shown superior than other methods as it significantly reduces time and effort for beginners.

### CROSS REFERENCE TO RELATED APPLICATIONS

This application take priority from a U.S. provisional application 62/202,699 filed Aug. 7, 2015. The provisional application is incorporated herein by reference in their entireties.

### TECHNICAL FIELD

The present invention relates to a method to teach and/or learn Chinese, in particularly, it is related to a method to teach and/learn Chinese Pinyin Finals.

### BACKGROUND OF THE INVENTION

Learning to read and write Chinese is not easy for someone who wants to acquire Chinese as a second language because Chinese characters are not phonetic language. To learn to read Chinese, Pinyin is needed. And Pinyin is one of prominent method to input Chinese characters into computers and smart phones today. Therefore it is important to master Pinyin.

Pinyin, or Hanyu Pinyin, is the official phonetic system for transcribing the Mandarin pronunciations of Chinese characters into the Latin alphabet in China, Taiwan and Singapore. It is often used to teach Standard Chinese and a Pinyin without diacritic markers is often used in foreign publications to spell/translate Chinese names to non-Chinese.

Chinese Pinyin are generally given in terms of Initials and Finals, which represent the segmental phonemic portion of the language, rather than letter by letter as in English. For example: the Chinese Pinyin “mai,” is combined of the Initial “m”, and the Final “ai”. Initials are initial consonants that always come first in Chinese Pinyin, while Finals are the rest parts, which come after the Initial.

Traditionally, students learn all Finals of Chinese by mechanical repetition—reciting new letters or combinations over and over again. This traditional method requires students who use Chinese as a second language to spend huge effort on simply memorizing Finals. Still, given the appeared similarity between Pinyin and American phonetics, many students tend to mix the Finals with English Alphabet without effective solution. Some educational organization has developed educational materials more vivid through advanced technologies, for example making letters more attractive, or use funny content to stimulate students' brain to help memory, but this method is not repeatedly useful for every student on all occasions. Such method neglects the fundamental and underlying connection within Finals, which are part of the foundation of the language itself.

To date, students are taught to memorize each Final by practicing it over and over again with pressure from parents or teachers. A more innovative and effective teaching and learning method is needed to help students to master Finals in Pinyin.

### SUMMARY OF THE INVENTION

The education method described herein is directed to a logical method that helps anyone learn and master Pinyin in a very short amount of time.

It is one object of the present invention to provide an easy way to approach Chinese for beginners. So a student can master Finals quicker and build up positive self-confidence.

It is another object of the present invention to provide a logical way to approach Chinese for beginners. So that once the underlining principle is understood, it is not easy to forget.

It is still another object of the present invention to provide a superior way to approach Chinese for beginners, even for learners whose mind have already been wired completely by American alphabet and phonetics. The method described herein offers less opportunity for a learner to get confused because the method starts from the very fundamental composition and pictorial layout of the Finals.

In accordance with the teachings of the present invention as disclosed herein, there is provided an education method for Pinyin, specifically for the Finals. The method starts with the fundamental six single Finals (vowels), and gradually learners are able to capture the formation of other 29 compound Finals with logic. The current method intentionally link single Finals and their corresponding compound Finals in a systematic way, and therefore all or most of Finals can be mapped logically in a learner's mind.

### BRIEF DESCRIPTION OF THE DRAWINGS

The invention will be readily understood by the following detail description in conjunction with the accompanying drawings, wherein like reference numerals designate like structural elements, and in which:

FIG. 1 is an illustration of six single vowels in Finals in accordance with the present invention;

FIG. 2 is an illustration of the first three single vowels in Finals and their corresponding compound Finals in four levels, in accordance with the present invention;

FIG. 3 is an illustration of the second three single vowels in Finals and their corresponding compound Finals in four levels, in accordance with the present invention; and

FIG. 4 is an illustration of 29 compound Finals and how each is built up from its corresponding single vowel.

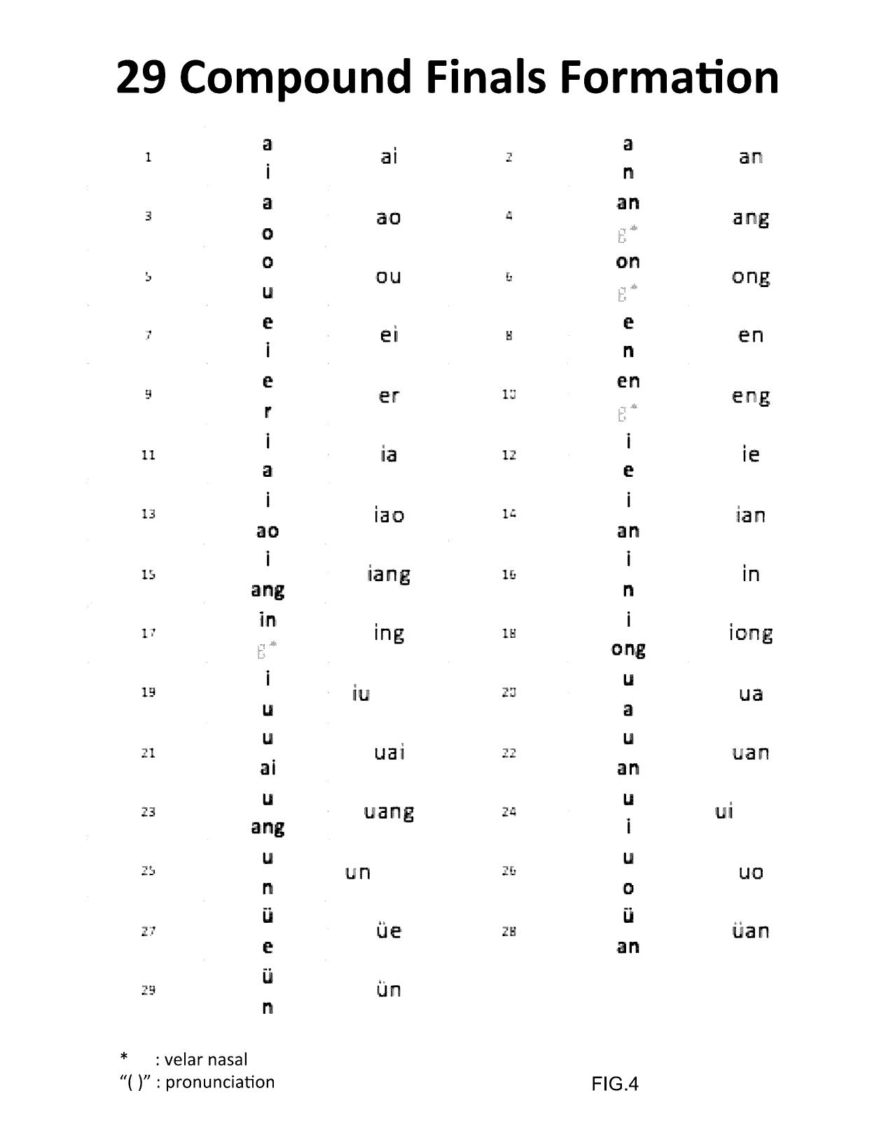

### DETAILED DESCRIPTION OF EXAMPLE EMBODIMENTS

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents that can be included within the spirit and scope of the described embodiments as defined by the appended claims.

Chinese Hanyu Pinyin or Pinyin, is made of Initials and Finals. The Initials include b, p, m, f, d, t, n, I, g, k, h, j, q, x, zh, ch, sh, r, z, c, and s. The Finals include “a, o, e, i, u, ü” and “ai, an, ao, ang, ou, ong, ei, en, er, eng, ia, ie, in, iu, iao, ian, iang, ing, iong, ua, ui, un, uo, uai, uan, uang, üe, ün, üan”. In many cases, students are taught to memorize each Final by practicing over and over again with pressure from parents or teachers. Some teachers also use funny content to stimulate students' brain to help memorize, but yet to find solution to associate each segment.

The present invention provides a method to group all or most of the Finals into two groups—single Finals and compound Finals. Then the two groups of the Finals are systematically networked under 4 general levels. From mastering the first level of single Finals, “a”, “o”, “e”, “i”, “u”, “ü”, 29 compound Finals are logically associated by attaching “a, e, i, o, u, r, n, g” to the single Finals, therefore learners only need to memorize six fundamental single Finals first, then other 3 levels of derivatives can be drawn from the first level by a more intellectual systematic approach instead of plain memorization.

The present invention offers a method of delivering a logic mind mapping and learning approach, which decomposes the complex learning material into simple components that can be logically connected. This innovative learning method saves significant time and energy for a learner especially a beginner. Traditionally, students would need to learn Finals through reciting each word again and again with little or no logic mapping. It's not only time-consuming but sometimes confusing as well. In many cases, students take months to remember all letters, which only takes days to forget. In contrast, the present invention provides a new method of mastering Finals of Chinese. Using this new method, a few hours are sufficient for beginners to grasp all the Finals, comparing to weeks or even months that is used for people to memorize before.

The education method disclosed herein, first divide Finals in Chinese Pinyin into two groups, single Finals and compound Finals. There are six single Finals and 29 compound Finals. The six single Finals are “a, o, e, i, u, ü”; and 29 Compound Finals are “ai, an, ao, ang, ou, ong, ei, en, er, eng, ia, ie, in, iu, iao, ian, iang, ing, iong, ua, ui, un, uo, uai, uan, uang, üe, ün, üan.” The total of 29 Compound Finals are built up from their corresponding single Finals.

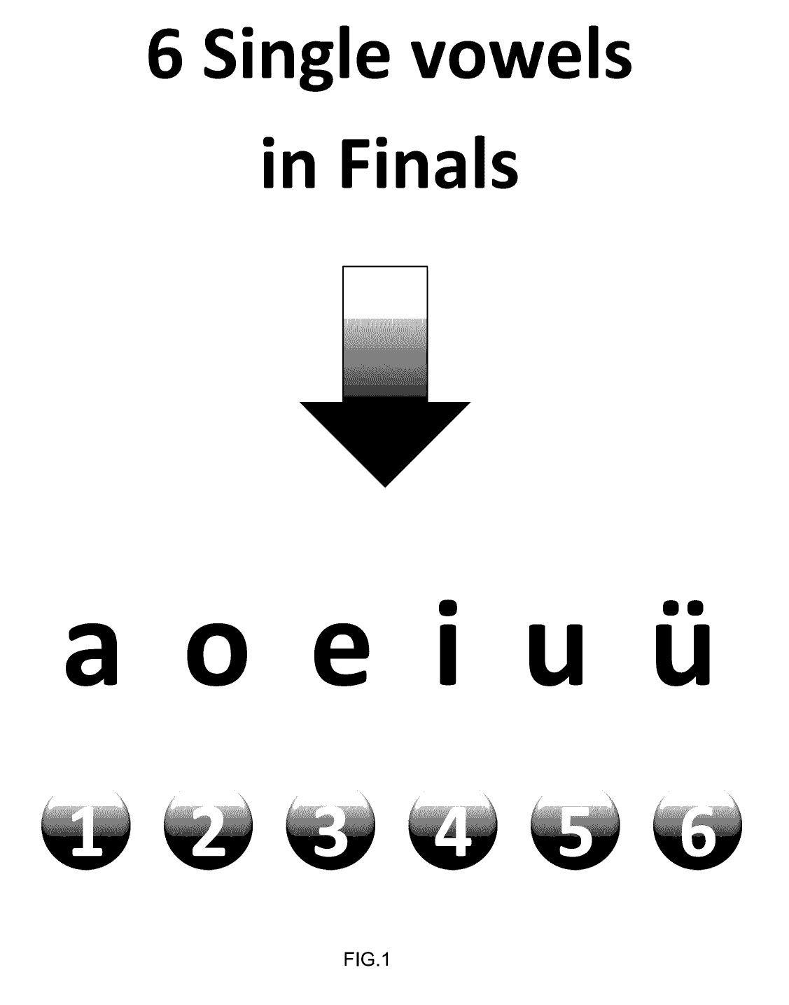

FIG. 1 lists all the six single Finals. On one hand, this first six single Final are very easy for an English speaking leaner to memorize, as it is the almost the same as the vowels in English language except the letter ü. On the other hand, the single Finals serves as foundations for the formation of upper level compound Finals.

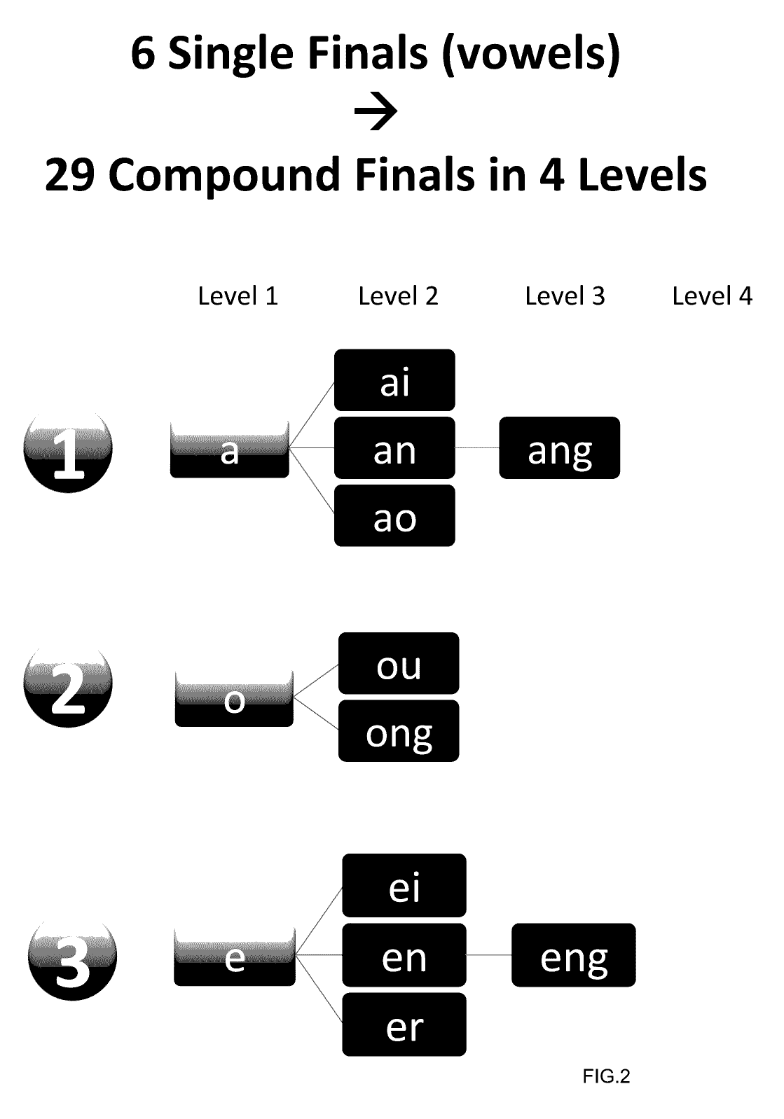

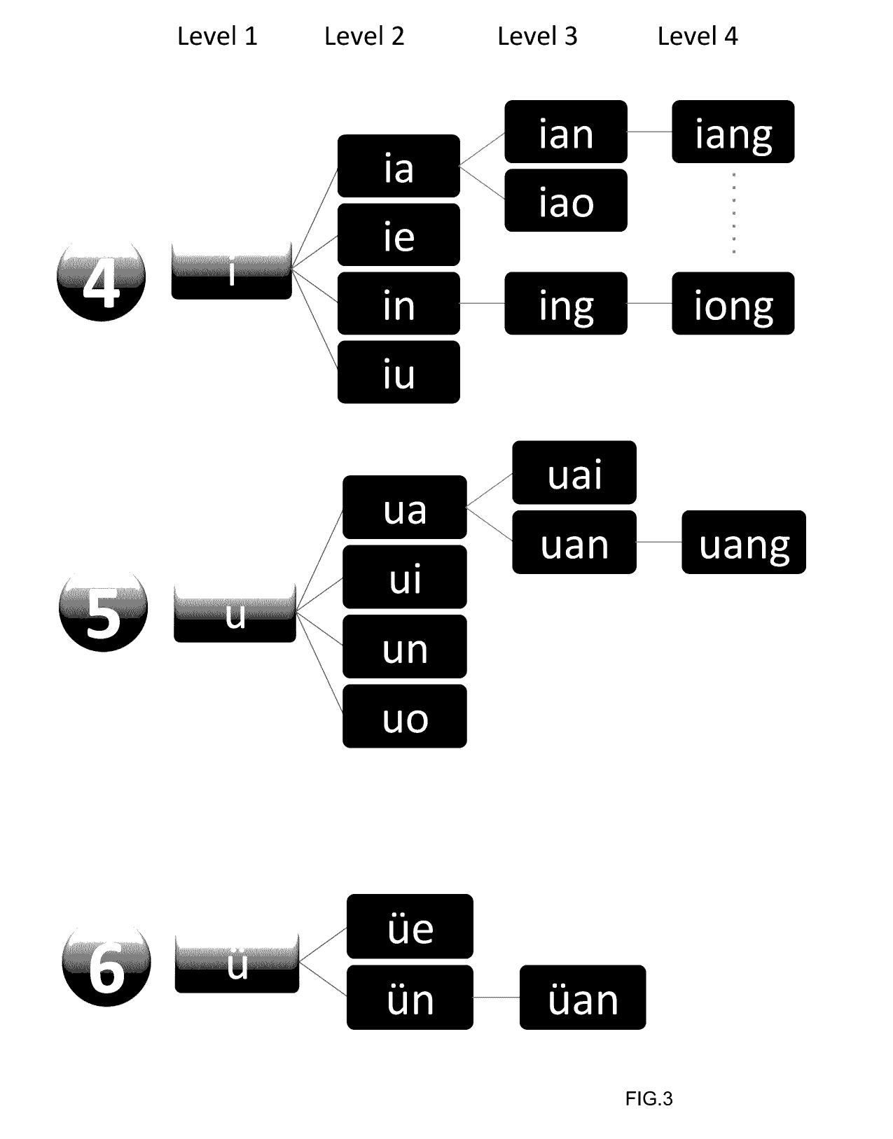

FIG. 2 lists the first three single Finals and the upper level of compound Final derived from them; and FIG. 3 lists the second three single Finals and the upper level of compound Final derived from them. It can been seen that from the tree or network structure illustrated in FIGS. 2 and 3, each learner can actively build up a logic of structure of 29 compound Finals from six single Finals (vowel).

For example, from one of the six single Finals (vowel)“a”—at the first level, three compound Finals “ai,” “an,” and “ao” are formed at the second level; then, from compound Final “an,” “ang” is formed at the third level. Accordingly, 4 derivatives “ai,” “an,” “ao,” and “ang” are formed in total.

In a second example, from one of the six single Finals (vowel)“o”—at the first level, two compound Finals “ou,” and “ong” are formed at the second level. Accordingly, 2 derivatives “ou,” and “ong” are formed in total.

In a third example, from one of the six single Finals (vowel)“e”—at the first level, three compound Finals “ei,” “en,” and “er” are formed at the second level. Then, from compound Final “en”, “eng” is formed at the third level. Accordingly, 4 derivatives “ei,” “en,” “er,” and “eng” are formed in total.

In a fourth example, from one of the six single Finals (vowel)“I”—at the first level, four compound Finals “ia,” “ie,” “in,” and “iu” are formed at the second level. Then, from “ia”, two compound Finals “iao,” and “ian” are formed at the third level. From “ian”, “iang” is formed at the forth level. And, from compound Final “in”, “ing” is formed at the third level. After “ing”, compound Final “long” is formed in forth level. Accordingly, 9 derivatives are formed in total.

In a fifth example, from one of the six single Finals (vowel)“u”—at the first level, four compound Finals “ua”, “ui”, “un”, “uo” are formed at the second level. Then, from “ua”, two compound Finals “uai,” and “uan” are formed at the third level. Then, from “uan”, compound Final “uang” is formed at the forth level. Accordingly, 7 derivatives are formed in total.

In a sixth example, from one of the six single Finals (vowel)“ü”—at the first level, three compound Finals “üe,” and “ün” are formed in second level. Then, from “ün”, compound Final “üan” is formed. Accordingly, 3 more derivatives “üe,” “üan” and “ün” are formed in total.

When the first level of single Finals are laid out as roots and the upper levels of the compound Finals will be displayed as branches from the roots. These are not only pictorially displayed to make a learner easily to remember the 29 compound Finals. More importantly, the association of compound Finals with single Finals (vowels) or dissecting complex compound Finals into their respective compositions, help learners to actively sound out the compound Finals logically, which is more like phonics rules in the English language.

In accordance with the aspects of the present invention, the method to teach and/or learn Finals in Chinese Pinyin comprises the steps of dividing Finals in Chinese Pinyin into two groups, a first group consisting of six single Finals and a second group consisting of 29 compound Finals, and associating each one of the single finals with at least one compound Finals. In the present invention, all the Finals are formed in a tree-like structure based from one of the six Finals. In another words, the six single Finals are served as first level roots, whereas different compound Finals are formed at secondary, ternary, quaternary levels.

Wherein the secondary level of compounded Finals include ai, an, ao, ou, ong, ei, en, er, ia, ie, in, iu, ua, ui, un, uo, üe, and ün.

Wherein the third level of the Finals include ang, eng, ian, iao, ing, uai, uan, and üan.

Wherein the fourth level of the Finals include lang, iong, and uang.

Referecing to FIGS. 2 and 3, each single Final can be used to build an individual logical mapping tree, having progressive levels, having single Finals at the root, and binary at the second level, tertiary compound Finals at the third level and quaternary compound Finals at the fourth level. The logical map method disclosed herein, comprises the following individual steps.

building a binary compound Finals ai, an, ao from single Final a;

building a binary compound Finals ou and ong from single Final o;

building a binary compound Finals ei, en and er from single Final e;

building binary compound Finals ia, ie, in and iu from single Final I;

building binary compound Finals ua, ui, un and uo from single Final u;

building binary compound Finals üe, and ün from single Final ü;

building a tertiary compound Final ang from the binary compound Final an;

building a tertiary compound Final eng from the binary compound Final en;

building tertiary compound Finals ian and iao from the binary compound Final ia;

building a tertiary compound Final ing from the binary compound Final in;

building tertiary compound Finals uai and uan from the binary compound Final ua;

building a tertiary compound Final üan from the binary compound Final ün;

building a quaternary compound Final iang from the tertiary compound Final ian;

building a quaternary compound Final iong from the tertiary compound Final ing; and

building a quaternary compound Final uang from the tertiary compound Final uang.

Further, each of 29 compound Finals can be divided into binary elements, including a first part and a second part, so that a learner can sound out the pronunciations of the compound Finals by combining the first part and second part.

For example, binary parts form each 29 Compound Finals are as the following.
Compound Final “ai” is made of first part “a” and second part “i”;
Compound Final “an” is made of first part “a” and second part “n”;
Compound Final “ao” is made of first part “a” and second part “o”;
Compound Final “ang” is made of first part “an” and second part “g”;
Compound Final “ou” is made of first part “o” and second part “u”;
Compound Final “ong” is made of first part “on” and second part “g”;
Compound Final “ei” is made of first part “e” and second part “i”;
Compound Final “en” is made of first part “e” and second part “n”;
Compound Final “er” is made of first part “e” and second part “r”;
Compound Final “eng” is made of first part “en” and second part “g”;
Compound Final “ia” is made of first part “i” and second part “a”;
Compound Final “ie” is made of first part “i” and second part “e”;
Compound Final “iao” is made of first part “i” and second part “ao”;
Compound Final “ian” is made of first part “i” and second part “an”;
Compound Final “iang” is made of first part “i” and second part “ang”;
Compound Final “in” is made of first part “i” and second part “n”;
Compound Final “ing” is made of first part “in” and second part “g”;
Compound Final “long” is made of first part “i” and second part “ong”;
Compound Final “iu” is made of first part “i” and second part “u”;
Compound Final “ua” is made of first part “u” and second part “a”;
Compound Final “uai” is made of first part “u” and second part “ai”;
Compound Final “uan” is made of first part “u” and second part “an”;
Compound Final “uang” is made of first part “u” and second part “ang”;
Compound Final “ui” is made of first part “u” and second part “i”;
Compound Final “un” is made of first part “u” and second part “n”;
Compound Final “uo” is made of first part “u” and second part “o”;
Compound Final “üe” is made of first part “ü” and second part “e”;
Compound Final “üan” is made of first part “ü” and second part “an”; and
Compound Final “ün” is made of first part “ü” and second part “n.”
The pronunciation of each 29 compound Finals comes from the combination of the first part and second part.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not meant to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages, including portability, adjustability to different heights, lightweight, stability, easy disassembly and assembly, etc. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

1. A method for teaching Chinese, the method comprising:
teaching 35 Finals in Chinese Pinyin as two groups,
a first group consisting of 6 single Finals and
a second group consisting of 29 compound Finals, associating each compound Final with a corresponding single Final in a logical manner and all the Finals are formed in a progressive tree-like structure, consisting of four levels: and
placing 6 single Finals at a first level as roots, and forming different compound Finals at a secondary, tertiary, and quaternary levels, respectively.

2. Method of claim 1, wherein the secondary level of the Finals include ai, an, ao, ou, ong, ei, en, er, ia, ie, in, iu, ua, ui, un, uo, üe, and ün.

3. Method of claim 1, wherein the third level of the Finals include ang, eng, ian, iao, ing, uai, uan, and üan,

4. Method of claim 1, wherein the fourth level of the Finals include lang, long, uang.

5. Method of claim 1, further comprising dividing each of the 29 compound Finals into binary pronunciation elements so that a learner can sound out the pronunciation.

6. A method to teach Chinese Pinyin, comprising building a logical map of Finals starting from any of six single Finals, being a, e, i, o, u, and ü.

7. The method of claim 6, further including building a binary compound Finals ai, an, ao from single Final a.

8. The method of claim 6, further including building a binary compound Finals ou and ong from single Final o.

9. The method of claim 6, further including building a binary compound Finals ei, en and er from single Final e.

10. The method of claim 6, further including building binary compound Finals ia, ie, in and iu from single Final i.

11. The method of claim 6, further including building binary compound Finals ua, ui, un and uo from single Final u.

12. The method of claim 6, further including building binary compound Finals üe, and ün from single Final ü.

13. The method of claim 7, further including building a tertiary compound Final ang from the binary compound Final an.

14. The method of claim 9, further including building a tertiary compound Final eng from the binary compound Final en.

15. The method of claim 10, further including building tertiary compound Finals ian and iao from the binary compound Final ia.

16. The method of claim 10, further including building a tertiary compound Final ing from the binary compound Final in.

17. The method of claim 11, further including building tertiary compound Finals uai and uan from the binary compound Final ua.

18. The method of claim 12, further including building a tertiary compound Final üan from the binary compound Final ün.

19. The method of claim 10, further including building a quaternary compound Final iang from the tertiary compound Final ian; and
building a quaternary compound Final iong from the tertiary compound Final ing.

20. The method of claim 10, further including building a quaternary compound Final uang from the tertiary compound Final uang.
